(19) United States
(12) Patent Application Publication
(10) Pub. No.: US 2013/0080754 A1
(43) Pub. Date: Mar. 28, 2013

(54) Service Profile Based Peripheral Component Interconnect Device Enumeration And Option ROM Loading

(71) Applicants: Venkatramani SriSai Ganesh, Karnataka (IN); Raghu Krishnamurthy, Santa Clara, CA (US); Chidananda Satya Kumar Patchava, Santa Clara, CA (US); Gururaja A. Nittur, Karnataka (IN)

(72) Inventors: Venkatramani SriSai Ganesh, Karnataka (IN); Raghu Krishnamurthy, Santa Clara, CA (US); Chidananda Satya Kumar Patchava, Santa Clara, CA (US); Gururaja A. Nittur, Karnataka (IN)

(73) Assignee: CISCO TECHNOLOGY, INC., San Jose, CA (US)

(21) Appl. No.: 13/239,524

(22) Filed: Sep. 22, 2011

(51) Int. Cl. G06F 9/24

(52) U.S. Cl. 713/2

(57) ABSTRACT

Techniques are provided for a computer device to receive and store data comprising information configured to indicate boot device parameters for devices to be initialized during a given boot sequence. Those devices that match the device parameters are initialized prior to loading the computer device's operating system. Devices that do not match the boot parameters are masked out by the BIOS, and Option ROM firmware is loaded and executed for those devices that match the boot parameters.

### TECHNICAL FIELD

The present disclosure relates to reducing operating system boot time in computer devices.

### BACKGROUND

When a computing device first powers up, a number of internal and external devices are started or initialized prior to the loading of the computer's operating system (OS) using a process called a power-on self-test. For example, in non-embedded computing systems, e.g., a desktop personal computer, the display, keyboard, mouse, memory, processor, and other connected accessories are activated and/or tested prior to loading the OS. The display, keyboard, and mouse are activated so the user can see and interact with the personal computer during the boot process. The boot process is managed by firmware known as a Basic Input/Output System (BIOS). The BIOS detects and initializes on-board, plug and play devices, and legacy devices, and maintains a list of such devices in non-volatile memory.

The user can manually configure the BIOS to execute firmware to start these devices in a particular order, e.g., by priority. During the power-on self-test process the BIOS generates and enumerates a list of devices for which optional device initialization firmware will be executed. The firmware may be part of the BIOS' firmware or contained as part of device flash memory. This section of device firmware is generally called an Option ROM. The current state of the art provides ways to reorder the priority of enumeration but does not give an operator the ability to fine tune the enumeration process. Moreover, entering the priority order is a manual, error prone process that also results in loading devices that are not necessary for the OS boot or operation, and thereby increases the time it takes to boot the OS. Long boot times impose undesirable delays in modern networks with hundreds of computers and their associated peripheral devices. Long boot times also increase the downtime for servers running high priority critical applications.

### BRIEF DESCRIPTION OF THE DRAWINGS

FIG. 1 shows an example network topology that supports development of service profiles that are configured control boot device enumeration and Option ROM loading for a computing device.

FIG. 2 is a flow chart depicting operations of process logic configured to enumerate and start devices during a computer device boot sequence according to a service profile.

FIG. 3 is an example block diagram of the server device that is configured to boot devices that match parameters contained in a service profile.

FIG. 4 is a flow chart of BIOS start up operations that are configured to start those boot devices that are described within the service profile prior to loading the OS.

### DESCRIPTION OF EXAMPLE EMBODIMENTS

Overview

Techniques are provided for a computer device to receive and store data comprising information configured to indicate boot device parameters for devices to be booted during a given boot sequence. Those devices that match the device parameters are initialized prior to loading the computer device's operating system. Devices that do not match the boot parameters are masked out by the BIOS, and Option ROM firmware is loaded and executed for those devices that match the boot parameters. In other words, the information defines a BIOS enumeration and Option ROM device set. This information, which may be in the form of a data file, is a policy within a service profile and is collectively referred to herein as a service profile.

### Example Embodiments

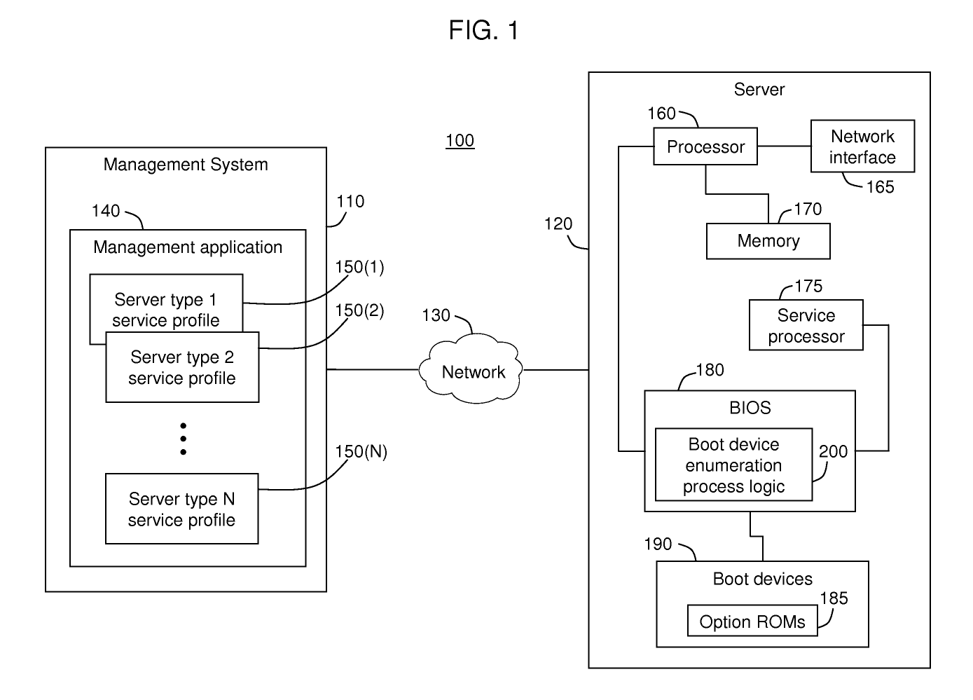

Referring first to FIG. 1, a networking environment 100 is shown. The environment 100 has a management system 110 and a server 120 coupled by a network 130. The management system 110 is used by a network operator to configure the server 120. The server 120 may be a stand alone server or part of a data center employing hundreds of such servers. The network 130 may be a local area network (LAN) for a campus or building, or may be a wide area network (WAN) that may communicate by way of the Internet. Accordingly, the management system 110 may provide a central management point for a large number of remote computing devices.

The management system 110 has a management application 140 provisioned with a plurality of service templates or profiles 150(1)-150(N). The server 120 has a processor 160, a network interface unit 165, a memory 170, a service processor 175, a BIOS 180, and a plurality of boot devices shown collectively at reference numeral 190. Each of the boot devices 190 has an Option ROM 185 as part of its firmware. Stored as part of the BIOS 180 are software instructions for boot device enumeration process logic 200. The BIOS 180 may be embodied by software stored in memory 170 or another memory device. The management system 110 may also have a processor, a network interface, a memory, etc., which are not shown for ease of illustration.

The processor 160 is, for example, a microprocessor, a microcontroller, systems on a chip (SOCs), or other fixed or programmable logic. The memory 170 may be any form of random access memory (RAM), read only memory (ROM), FLASH memory, disk storage, or other tangible (non-transitory) memory media (device or devices) that stores data used for the techniques described herein. The memory 170 may be separate or part of the processor 160. The memory 170 is configured to store executable instructions for the BIOS 180 and for process logic 200. For example, one or more computer readable storage media is encoded with software comprising computer executable instructions and when the software is executed operable to perform the operations of the process logic 200. Said another way, instructions for performing the process logic 200 may be stored in the memory 170 for execution by the processor 160 such that when executed by the processor, causes the processor to perform the operations describe herein in connection with the remainder of the figures. Although shown in connection with BIOS 180, process logic 200 may be stored on other tangible non-transitory (but physically portable or movable) memory such as forms of read only memory (ROM), erasable/programmable or not, or other non-volatile memory (NVM), e.g., boot memory for server 120. It should be understood that any of the devices in described herein, e.g., management system 110, may be configured with a similar hardware or software configuration as server 120.

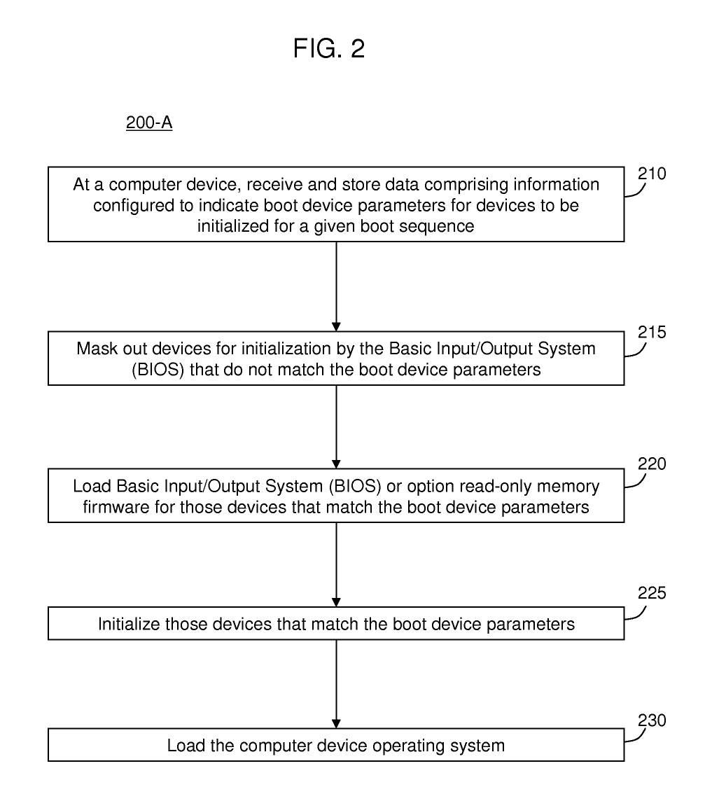

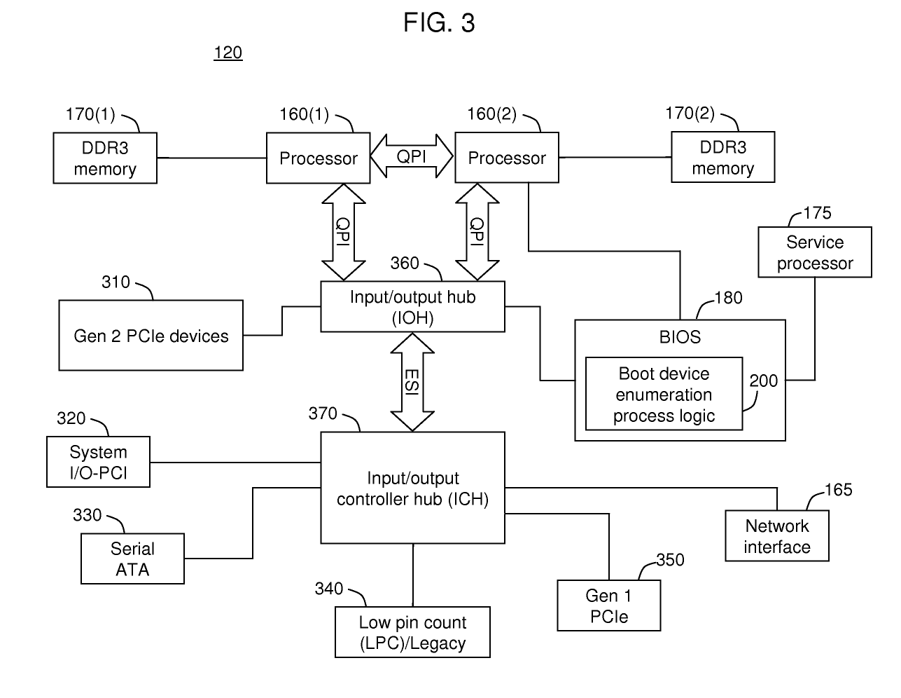

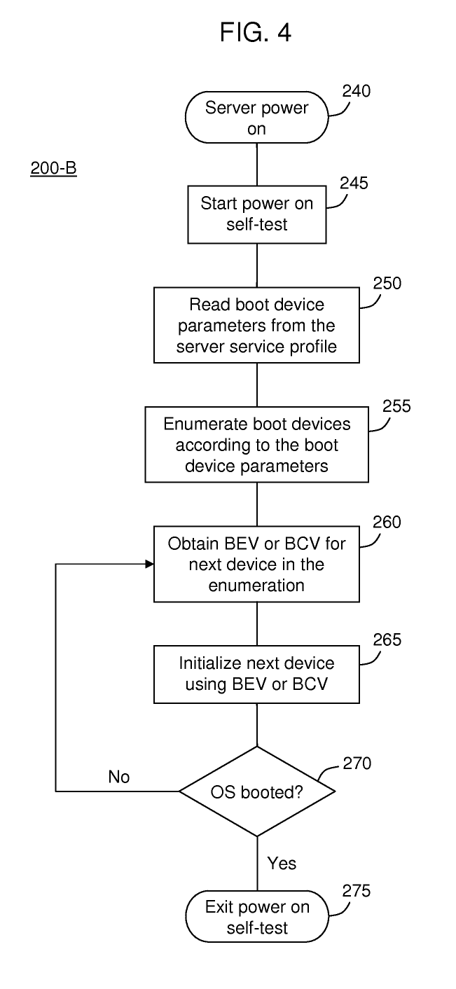

The functions of the processor 160 may be implemented by a processor or computer readable tangible (non-transitory) medium encoded with instructions or by logic encoded in one or more tangible media (e.g., embedded logic such as an application specific integrated circuit (ASIC), digital signal processor (DSP) instructions, software that is executed by a processor, etc.), wherein the memory 170 stores data used for the computations or functions described herein (and/or to store software or processor instructions that are executed to carry out the computations or functions described herein). Thus, functions of the process logic 200 may be implemented with fixed logic or programmable logic (e.g., software or computer instructions executed by a processor or field programmable gate array (FPGA)). The process logic 200 executed by a computer, e.g. server 120, has been generally described above and will be further described in connection with FIGS. 2 and 3, and a specific example embodiment will be described in connection with FIG. 4.

It is to be understood that the configuration shown in FIG. 1 is a very simple representation and that there are, in practice, many more servers and computing devices in any given network environment. Furthermore, the term “server” or “computer” is meant to refer to any device that boots using BIOS like techniques. For example, the techniques described herein are applicable to other computing devices, e.g., personal computers (PCs), embedded devices, network appliances, rack mount devices, as well as servers. Thus, the configuration shown in FIG. 1 is only meant to be an example for purposes of describing the techniques herein.

A network or data center operator uses the management application 140 in management system 110 to configure the server 120 via service processor 175. In this regard, the management application 140 and the service processor 175 BIOS may communicate using known management protocols, e.g., the Systems Management Architecture for Server Hardware (SMASH) specifications, the Intelligent Platform Management Interface (IPMI) specification, or any proprietary messaging protocol. The network interface 165 is configured to transmit and receive communications over the network 130. The service processor 175 may be referred to as a server management controller (SMC) or Baseboard Management Controller (BMC). It may be implemented using an ASIC or special hardware with firmware for server management tasks.

The server type service profiles 150(1)-150(N) are configuration files that control boot device enumeration and Option ROM loading for a given computing device along with other device provisioning information. As mentioned above, the BIOS performs device enumeration and Option ROM loading/execution during the power-on self-test (POST) and is a well understood process. The techniques described herein provide a mechanism to override the BIOS' regular device enumeration and Option ROM loading process. For example, server type service profiles 150(1)-150(N) may be markup language grammar files, e.g., extensible markup language (XML) files that contain a list of devices or parameters describing devices that are to be enumerated during POST. Accordingly, a service profile may be formulated in BIOS XML. Devices not identified in the server type service profiles are not enumerated during POST.

When a computing device first powers up, a number of internal and external devices, referred to Initial Program Load (IPL) devices, are activated or booted prior to the loading of the computer's operating system. For example, in non-embedded computing systems, e.g., a desktop personal computer, the display, keyboard, and mouse are activated so the user can see and interact with the personal computer during the boot process.

The BIOS detects on-board, plug and play devices, and BIOS aware IPL devices, and maintains a list of such devices in non-volatile memory. On-board devices are devices that are permanently attached to the computing substrate, e.g., a motherboard. A BIOS aware IPL device is a device from which the main computer operating system can be loaded, e.g., by way of a hard drive or network adapter. The user can configure the BIOS to load or boot IPL devices in a particular order, i.e., by priority. However, as mentioned above, entering the priority order is a manual process that requires access to each device's BIOS configuration screen.

In this example, the service profiles are labeled as “server type” service profiles to illustrate one introductory class of service profiles. In a data center there may be many server types, e.g., web servers, database servers, and the like. Servers that have similar hardware configurations may use a common service profile for the boot process. As such, server type service profile 150(1) may be for web servers with hardware configuration X, server type service profile 150(2) may be for web servers with hardware configuration Y, server type service profile 150(3) may be for database servers, server type service profile 150(4) may be for a custom device configuration, and so on. Different classes or types of service profiles are described below.

When it is desirable for a computer or server to have a custom hardware boot process, a user may interact with the management application 140 to specify a BIOS enumeration and Option ROM load configuration, i.e., a service profile. Once specified, the management system 110 may transmit the service profile to the remote computing system, e.g., server 120. In one example, the service processor 175, e.g., an SMC/BMC, on the remote computing system receives the service profile. In turn, upon power up or reboot, the BIOS, e.g., BIOS 180, in connection with service processor 175 and boot device enumeration process logic 200 as part of BIOS 180, enumerates devices and loads their corresponding firmware for execution by the processor, e.g., processor 160. The firmware may be part of the BIOS firmware or Option ROM firmware, e.g., as loaded on Option ROMs 185.

Referring next to FIG. 2, a flow chart depicting operations of process logic configured to enumerate and start (initialize) devices during a computer device boot sequence according to a service profile will now be described. In the flowchart, process logic 200 has been labeled as 200-A and generally depicts a service profile based boot sequence. A specific example of service profile based BIOS boot sequence will be described in connection with FIG. 4 and is labeled 200-B.

At 210, at a computer device, data comprising information configured to indicate boot device parameters for devices to be booted for a given boot sequence is received and stored. The data may be in the form of a file, data structure, or data stream that is received, e.g., via a network interface, and then stored on a storage device, e.g., a disk or non-volatile memory (NVM). The data indicate which devices to initialize during POST. At 215, devices that do not match the boot device parameters are masked out by the BIOS. At 220, Option ROM firmware is loaded for those devices that match the boot device parameters. At 225, the loaded firmware is executed in order to initialize devices that match the boot device parameters and, at 230, the OS is loaded.

The process logic 200 replaces part of the POST process. At an early stage of POST, the BIOS firmware enters the boot device enumeration process logic 200 and when process logic 200 finishes, the BIOS returns to its normal processing. Process logic 200 eliminates booting unnecessary devices. For example, current server operations specify boot devices and other associated information such as storage logical unit number (LUN), network interface card, etc. However, the BIOS does not necessarily use this information during POST or pre-OS boot. The BIOS merely enumerates all the devices present on the system, and executes Option ROM and utilities for all of the devices. Accordingly, the current conventional process adds delay to the system boot. In addition, the current process, that does not employ the techniques described herein, performs unnecessary operations during special boots, e.g., such as server discovery and provisioning boots by a management software application.

The techniques described herein optimize the boot process by specifying only those device(s) of interest for booting along with their associated information. The BIOS receives the information in a platform specific manner, e.g., by using an XML interface through a service processor. By way of example, the information transferred to the BIOS for a single device could be as follows:

### <Boot_Controller>

<identifier=“1”/>

### <Name=“LSI MegaRAID”/>

### <Slot=“Slot_{—}6”/>

### </Boot_Controller>

The markup language snippet has an identifier, a device name, and a physical location. A series of such snippets may be contained in the service profile. The server management entity, e.g., service processor 175 (FIG. 1), can obtain the information about devices presently installed and their associated LUNs and ports through a system management BIOS (SMBIOS) or similar XML communication from the server to service processor 175 as part of server inventory communication to service processor 175. This information would be shared by the service processor 175 with any management application running centrally on an on-demand basis.

Upon receiving the service profile during POST, the BIOS masks off devices not requested for boot/initialization, and selectively enumerates and controls the Option ROMs. Alternatively, BIOS tokens may be used to indicate devices to boot and devices to ignore. In other examples, the service profile may contain a series of slot numbers that identify the locations of the devices to boot during POST. The order of the slot numbers indicates the boot order. The service profile may specify whether on-board, pluggable, card-type, or mezzanine devices should be booted first. The service profile may specify the order in which Peripheral Component Interconnect (PCI) and PCI Express (PCIe) devices are enumerated and booted.

Turning to FIG. 3, a block diagram of server 120 is shown in greater detail. Server 120 comprises first and second processors 160(1) and 160(2), respectively, and two sets of memory 170(1) and 170(2). Server 120 includes BIOS 180, the network interface 165, the service processor 175, and a plurality of on-board, pluggable, and other peripheral devices. In this regard, server 120 comprises a plurality of second generation (Gen 2) PCIe devices 310, a system I/O (SIO) 320 interconnect for PCI devices, serial Advanced Technology Architecture (SATA) 320 devices (e.g., hard drives), low pin count (LPC) legacy devices 340, and first generation (Gen 1) PCIe devices 350.

Connecting the various components are an input/output hub (IOH) and an input/output controller hub (ICH). The arrangement shown in FIG. 3 generally follows the Intel™ dual processor server architecture, as one example. For example, the processors 160(1) and 160(2), and the IOH 360 communicate using Quick Path Interconnect (QPI), while IOH 360 to ICH 370 communication uses the Enterprise Southbridge Interface (ESI).

When server 120 is powered on or otherwise rebooted, the BIOS initiates the POST procedures as described above. Traditionally, the BIOS 180 would enumerate the devices, test some of the devices, and initialize the devices in enumeration order. Some of the devices that are standard or legacy devices for a given device may have their firmware loaded within the BIOS, while non-standard devices may have their firmware stored as Option ROM within device itself. For example, certain I/O devices, hard drives (e.g., a SATA 330 device), SIO 320, and LPC 340 devices may have firmware stored on the BIOS 180, while network interface 165, Gen 1 PCIe devices 350, and Gen 2 PCIe devices 310 have their firmware stored as Option ROMs.

As final part of the traditional POST process, an attempt may be made to boot the computer by first trying to find an OS on a floppy disk drive. If there were no media in the floppy drive or if there were incorrect media in the floppy drive, the boot would fail. The BIOS would then attempt to boot from the next device, e.g., a network adapter. The BIOS would boot the network adapter and then attempt to load the OS by way of the network adapter. Should that fail, the BIOS may next attempt a boot from a local hard drive, and so on. The point is that many boot attempts may be made without success, and with each boot attempt wasting a certain amount of time.

To further illustrate the problem, current BIOS operations enumerate PCIe devices in the order of their bus, device, and function (BDF). The BDF is a numerical triplet that identifies a PCIe device and location. Therefore, using conventional boot techniques the device enumeration takes place according to the placement of devices on the board, e.g., the host or mother board. During this process, a device gets initialized and is given a chance to run any utilities and configuration tools. This section of code is called an Expansion ROM or Option ROM plug-in. This ROM plug-in supplies logic for installing necessary protocols and handlers used by the device later in the boot stages.

By design the Intel x86 architectures provide a limited space of 128 kilobytes (KB) for the Option ROMs under the 1 megabyte (MB) memory region. A memory size of 128 KB would satisfy the low end servers that do not accommodate many PCIe slots or connectivity options. However, in medium and high end servers that have multiple PCIe slots enabling greater expansion capabilities, e.g., 10 PCIe slots, the Expansion ROM space is not big enough to hold all the initialization code and boot handlers.

Typically Option ROM space is occupied in the order of enumeration. Early in the boot process, i.e., in the BDF enumeration, if PCIe devices occupy the Option ROM space completely, then in the later stages of enumeration, there may be PCIe devices that cannot install their boot handlers and initialization routines. This leads to the non-availability of later stage PCIe devices during the boot stages and these devices are unable to boot the system.

Referring to FIG. 4, a flow chart depicts BIOS start up operations according to a specific example 200-B of the boot device enumeration process logic 200 for server 120. At 240, the server is powered on, rebooted, or given special boot instructions. At 245, POST is started. At 250, the boot device parameters are read from the service profile. At this point in time, the service profile may be dynamically provided to the server, read from an XML file, or read from NVM. It should be understood that the service profile may be downloaded at an earlier time and converted to a form that is easily interpreted by the BIOS and/or service processor 175. For example, the service profile may be contained in an expansion header as part of the Option ROM.

At 255, boot devices are enumerated according to the boot device parameters. Devices that match the boot device parameters are placed in the enumeration list according to the boot device parameter. By way of example, the service profile may contain a simple configuration that allows a network operator to select from the following menu options:
Boot network adapters first, then remaining devices
Boot storage adapters first, then remaining devices
Boot network adapter before storage adapters
Boot storage adapter before network adapters
Normal BDF
Disable All
   In an alternate configuration, the selection may provide:
On-board devices, then pluggable devices
Pluggable devices, then on-board devices
Only on-board devices
Only pluggable devices
Normal BDF
Disable All

In other examples, the network operator can list individual device or device locations on the board, as described above. The network operator can use BOOLEAN logic to form combinations of the above mentioned enumeration options to achieve any desired level of device boot granularity.

At 260, the bootstrap entry vector (BEV) or boot connection vector (BCV) for the next device in the enumeration is obtained. A BEV is a pointer that points to code inside an Option ROM that will directly load an OS. The BEV resides in a plug and play (PnP) option ROM Expansion Header. A BCV is a pointer that points to code inside the option ROM that will perform device initialization, detect if a peripheral (such as a Small Computer System Interface (SCSI) hard drive) is attached, and optionally hook interrupt (INT) 13h. The BCV resides in a PnP option ROM Expansion Header. At 265, the BEV or BCV is used to boot the next device.

At 270, it is determined if the OS has been booted, i.e., loaded and executed. If not, process logic 200 returns to 260 and attempts to boot the next device. If the OS has booted, then at 275, server 120 exits the POST routine. It should be noted that the BIOS may continue to perform other processing such as booting any remaining devices that were not necessary for OS boot.

Using the techniques described herein the server manager, e.g., service processor 175 and associated management software, can achieve fine granular control over which devices aid the boot process and those that do not. Accordingly, the techniques described herein reduce the boot time of a server by eliminating unnecessary device enumeration and Option ROM execution during boot. Information about required devices for a successful boot can be obtained through service profiles including BIOS XML.

In summary, the techniques and apparatus described herein provide for a computer device to receive and store data comprising information configured to indicate boot device parameters for devices to be initialized during a given boot sequence. Those devices that match the device parameters are initialized prior to loading the operating system of the computer device. Devices that do not match the boot parameters are masked out by the BIOS, and Option ROM firmware is loaded and executed for those devices that match the boot parameters. In so doing, the information defines a BIOS enumeration and Option ROM device set. The boot device parameters comprise priority information indicating that on-board, card, mezzanine, or pluggable devices are to be booted first, and wherein booting comprises booting on-board, card, mezzanine, or pluggable devices according to the priority information.

The boot parameters may comprise one or more of a boot priority indicator, device identifier, device name, and device location, and devices are booted based on one or more of the boot priority indicator, the device identifier, the device name, and the device location. In another example, the boot parameters are device adapter classifications that may include one or more of network adapters, storage adapters, peripheral device adapters, and custom adapters. The boot parameters may include boot device information for one or more of Peripheral Component Interconnect (PCI) devices and PCI Express devices. The BEV BCV may be obtained from those devices that match the boot parameters.

The above description is intended by way of example only. Various modifications and structural changes may be made therein without departing from the scope of the concepts described herein and within the scope and range of equivalents of the claims.

What is claimed is:

1. A method comprising:
at a computer device, receiving and storing data comprising information configured to indicate boot device parameters for devices to be initialized for a given boot sequence; and
initializing those devices that match the boot device parameters prior to loading the computer device operating system.

2. The method of claim 1, wherein initializing comprises loading and executing Basic Input/Output System (BIOS) or option read-only memory firmware for those devices that match the boot device parameters.

3. The method of claim 1, wherein initializing comprises masking out devices for initialization by the Basic Input/Output System (BIOS) that do not match the boot device parameters.

4. The method of claim 1, wherein the boot device parameters comprise priority information indicating that on-board, card, mezzanine, or pluggable devices are to be initialized first, and wherein initializing comprises booting on-board, card, mezzanine, or pluggable devices according to the priority information.

5. The method of claim 1, wherein the boot parameters comprise one or more of a boot priority indicator, device identifier, device name, and device location, and wherein initializing comprises initializing devices based on one or more of the boot priority indicator, the device identifier, the device name, and the device location.

6. The method of claim 1, wherein the boot parameters comprise device adapter classifications, and wherein initializing comprises initializing devices in adapter classes that match the device adapter classifications.

7. The method of claim 6, wherein the device adapter classifications comprise one or more of network adapters, storage adapters, peripheral device adapters, and custom adapters.

8. The method of claim 1, further comprising obtaining from those devices that match the boot parameters one or more of their corresponding boot connection vector and bootstrap entry vector.

9. The method of claim 1, wherein the boot parameters comprise boot device information for one or more of Peripheral Component Interconnect (PCI) devices and PCI Express devices.

10. The method of claim 1, further comprising:
receiving the data from a network management device.

11. An apparatus comprising:
a network interface unit configured to provide communications over a network; and
a processor configured to:
receive, via the network interface unit, data comprising information configured to indicate boot device parameters for devices to be initialized for a given boot sequence;
store the data; and
initialize devices that match the boot device parameters prior to loading the computer device operating system.

12. The apparatus of claim 11, wherein the processor is configured to load and execute a Basic Input/Output System (BIOS) or option read-only memory firmware for devices that match the boot device parameters.

13. The apparatus of claim 11, wherein the processor is further configured to mask out devices for initialization by the Basic Input/Output System (BIOS) that do not match the boot device parameters.

14. The apparatus of claim 11, wherein the processor is configured to use boot device parameters comprising priority information indicating that on-board, card, mezzanine, or pluggable devices are to be initialized first, and to initialize the on-board, card, mezzanine, or pluggable devices according to the priority information.

15. The apparatus of claim 11, wherein the processor is configured to use boot device parameters comprising one or more of a boot priority indicator, device identifier, device name, and device location, and to initialize devices based on one or more of the boot priority indicator, the device identifier, the device name, and the device location.

16. The apparatus of claim 11, wherein the processor is configured to use boot device parameters comprising device adapter classifications and to initialize devices in adapter classes that match the device adapter classifications.

17. The apparatus of claim 16, wherein the processor is configured to use adapter classifications comprising one or more of network adapters, storage adapters, peripheral device adapters, and custom adapters, and to initialize devices in adapter classes that match the device adapter classifications.

18. The apparatus of claim 11, wherein the processor is further configured to obtain from those devices that match the boot parameters one or more of their corresponding boot connection vector and bootstrap entry vector.

19. One or more computer readable storage media encoded with software comprising computer executable instructions and when the software is executed operable to:
receive data comprising information configured to indicate boot device parameters for devices to be initialized for a given boot sequence;
store the data; and
initialize those devices that match the boot device parameters prior to loading the computer device operating system.

20. The computer readable storage media of claim 19, wherein the instructions operable to initialize comprise instructions operable to load and execute a Basic Input/Output System (BIOS) or option read-only memory firmware for those devices that match the boot device parameters.

21. The computer readable storage media of claim 19, further comprising instructions operable to mask out devices for initialization by the Basic Input/Output System (BIOS) that do not match the boot device parameters.

22. The computer readable storage media of claim 19, wherein the instructions operable to initialize comprise instructions operable to initialize those devices that match the boot device parameters comprising priority information indicating that on-board, card, mezzanine, or pluggable devices are to be initialized first, and to initialize the on-board, card, mezzanine, or pluggable devices according to the priority information.

23. The computer readable storage media of claim 19, wherein the instructions operable to initialize comprise instructions operable to initialize those devices that match the boot device parameters comprising one or more of a boot priority indicator, device identifier, device name, and device location, and to initialize devices based on one or more of the boot priority indicator, the device identifier, the device name, and the device location.

24. The computer readable storage media of claim 19, wherein the instructions operable to initialize comprise instructions operable to initialize those devices that match the boot device parameters comprising device adapter classifications and to initialize devices in adapter classes that match the device adapter classifications.

25. The computer readable storage media of claim 24, wherein the instructions operable to initialize comprise instructions operable to initialize those devices that match the boot device parameters comprising one or more of network adapters, storage adapters, peripheral device adapters, and custom adapters, and to initialize devices in adapter classes that match the device adapter classifications.

26. The computer readable storage media of claim 19, further comprising instructions operable to obtain from those devices that match the boot parameters one or more of their corresponding boot connection vector and bootstrap entry vector.
